(19) United States
(12) Patent Application Publication
(10) Pub. No.: US 2016/0210688 A1
(43) Pub. Date: Jul. 21, 2016

(54) ENTERPRISE RESOURCE MANAGEMENT

(71) Applicant: BIGRENTZ INC., Irvine, CA (US)

(72) Inventors: Liam Stannard, Huntington Beach, CA (US); Dallas Imbimbo, Irvine, CA (US); Brandon Huff, Newport Beach, CA (US)

(73) Assignee: BIGRENTZ INC., Irvine, CA (US)

(21) Appl. No.: 14/997,296

(22) Filed: Jan. 15, 2016

Related U.S. Application Data
(60) Provisional application No. 62/103,813, filed on Jan. 15, 2015.
(60) Provisional application No. 62/159,077, filed on May 8, 2015.

(51) Int. Cl. G06Q 30/06; G06Q 10/08; G06Q 10/06

(52) U.S. Cl. CPC G06Q 30/0645; G06Q 10/06315; G06Q 10/063114; G06Q 10/087; G06Q 30/0611

(57) ABSTRACT

A management system improves many aspects of equipment rentals by tracking, processing and analyzing information related to the equipment rentals. Improvements involve: tiering of customer information, matching suppliers and customers, utilization opportunities and load balancing, financing and risk management, equipment substitution, a rental inventory portal, idle equipment optimization, managing the life cycle of equipment, extension prediction, hardware tracking/analysis and advertising.

### CROSS-REFERENCE TO RELATED APPLICATION(S)

This application claims priority under 35 U.S.C. §119(e) of the U.S. Provisional Patent Application Ser. No. 62/103,813, filed Jan. 15, 2015 and titled, “ENTERPRISE RESOURCE MANAGEMENT” and the U.S. Provisional Patent Application Ser. No. 62/159,077, filed May 8, 2015 and titled, “ENTERPRISE RESOURCE MANAGEMENT,” which are both hereby incorporated by reference in their entireties for all purposes.

### FIELD OF THE INVENTION

The present invention relates to the field of rental management. More specifically, the present invention relates to the planning and organization of rental management.

### BACKGROUND OF THE INVENTION

The rental industry's ability to deliver an excellent experience to both renter and rentee is limited. Additionally, a disjointed and disorganized rental equipment industry would benefit greatly from improved organizational strategies and technologies.

### SUMMARY OF THE INVENTION

A management system improves many aspects of equipment rentals by tracking, processing and analyzing information related to the equipment rentals. Improvements involve: tiering of customer information, matching suppliers and customers, utilization opportunities and load balancing, financing and risk management, equipment substitution, a rental inventory portal, idle equipment optimization, managing the life cycle of equipment, extension prediction, hardware tracking/analysis and advertising.

### BRIEF DESCRIPTION OF THE DRAWINGS

FIG. 1 illustrates a diagram of an exemplary management system according to some embodiments.

FIG. 2 illustrates a flowchart of a method of implementing a management system according to some embodiments.

FIG. 3 illustrates a block diagram of an exemplary computing device configured to implement the management system according to some embodiments.

FIG. 4 illustrates a network of devices configured to implement the management system according to some embodiments.

FIG. 5 illustrates a diagram of the management system according to some embodiments.

### DETAILED DESCRIPTION OF THE PREFERRED EMBODIMENT

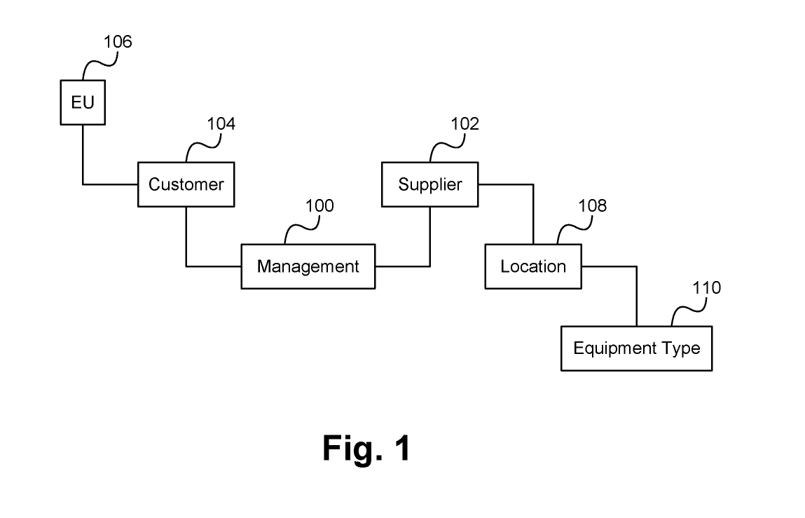

FIG. 1 illustrates a diagram of an exemplary management system according to some embodiments. A management entity 100 facilitates rentals of equipment or other goods and services between a supplier 102 and a customer 104. The involvement of the management entity 100 is able to be variable or dependent upon the implementation. In some embodiments, the management entity 100 does not own any of the equipment to be rented, or the management entity 100 owns some or all of the equipment to be rented. Similarly, the management entity 100 may or may not service or haul any of the equipment. In some embodiments, the management entity 100 utilizes one or more applications or programs to perform the implementations/steps/methods described herein. For example, devices such as personal computers, laptops, smart phones, and/or servers are programmed with one or more computing programs to perform the management functions described herein.

The customer 104 communicates with the management entity 100 to rent equipment. In some embodiments, the customer 104 is the end user of the equipment, and in some embodiments, the customer 104 works for a separate end user 106. For example, a company putting antennas up is the customer, and the telecom company using the antenna is the end user.

The supplier 102 is the company that has the equipment for rent. Typically, there are many separate suppliers available with a variety of the same and different equipment for rent. The supplier 102 has one or more locations 108, and at each location 108, the supplier 102 has equipment 110. The equipment 110 is able to be any type of equipment such as aerial equipment (e.g., boom lifts, scissor lifts, fork lifts, others), earth moving equipment (e.g., excavators, mini-excavators, backhoes, wheel loaders), construction equipment, sports equipment, entertainment/party equipment, activity equipment, tools, vehicles, generators and/or any other equipment/items that are able to be rented.

When a customer 104 uses the management entity 100 to rent equipment from the supplier 102, the customer 104 receives the specified equipment for a specified amount of time. In some instances, the customer 104 is able to receive equipment from multiple suppliers 102. For example, Customer X needs two boom lifts, a fork lift and an excavator, and Supplier A only has one boom lift and a fork lift, but Supplier B has a boom lift and an excavator, so the management entity 100 is able to coordinate the rental, so that Customer X receives all of the equipment it needs from Supplier A and Supplier B. By utilizing the management entity 100, Customer X does not need to waste the time and effort of contacting and multiple suppliers, or manage commercial relationships such as payment, credit terms, and invoicing with multiple suppliers. Additionally, if conditions change (e.g., weather causes a delay), the management entity 100 provides a single point of contact for Customer X. In another example, a sports network needs twenty scissor lifts for their cameras for a sporting event which is taking place over many days in two different cities. Instead of the sports network contacting multiple suppliers, including suppliers in different cities, to determine equipment availability, condition, and other important aspects, the sports network is able to contact the management entity 100 which has the desired information or is able to easily obtain the information and perform/facilitate the needed rentals.

In some embodiments, the management entity 100 rents the equipment from the supplier 102 and rents/provides the equipment to the customer 104 (without the management entity 100 physically acquiring the equipment). In some embodiments, the management entity 100 connects the supplier 102 with the customer 104, but does not participate in the actual rental.

### Tiering Suppliers by Location and Equipment

By having a knowledge base of suppliers' locations, price, credit terms, prior behavior in cases of dispute, equipment/inventory, quality and characteristics of the equipment (e.g., clean, dirty, damaged, functionality, failure rate, age, number of times rented, hours of operation, color, particular features), quality of service (e.g., timely, responsive to questions/complaints/issues), quality of the mechanic for the equipment, jobs/rentals performed/completed, commentary/reviews of customers/end users, commentary/reviews of the management entity, number of times a rental was proposed by the management entity, number of times a rental was successfully concluded by the management entity with said supplier, and any other information, a tiered structure of suppliers is able to be generated and utilized. Additional factors that are considered when ranking and selecting suppliers include: predicted customer satisfaction, type of job (e.g., risky/dangerous, high profile or visible to the public, subject to particular service-level-agreement, in a difficult to reach geography), customer history, and others. Any type of calculation and analysis are able to be performed. For example, an average timeliness factor is calculated by taking the amount of times a supplier is reported as being late or the amount of the supplier is late by and averaged, and then suppliers are able to be compared with the average and/or each other. For example, a ranking of suppliers based on timeliness is able to be generated where the top of the rankings is the supplier that is on time most often. Further calculations include factoring the specific details of the equipment and job, in addition to the overall supplier factors. For example, a supplier may have a stellar track record with timeliness of boom lifts, but a poor track record with timeliness of scissor lifts. While both sets of data may be considered, the track record for boom lifts may be more heavily weighted for a job involving boom lifts. More complicated analysis is able to be performed such as calculating and comparing many factors and giving/using different weights to each of the factors.

When the management entity 100 requests equipment from a supplier 102, and the management entity 100 determines that the supplier 102 does not have the equipment, then that is considered a “lost rental” in terms of supplier 102. Lost rentals can signal that supplier 102 should consider purchase or acquisition of said equipment. The management entity 100 is able to track equipment inventory, including if the supplier 102 purchases equipment they are supposed to purchase. This information is also able to be used when analyzing and rating/ranking the suppliers.

Any of the analysis is able to be provided to the supplier 102. For example, reports are able to be generated which indicate where the supplier 102 ranks amongst competitors in teams of specified aspects or overall. Additionally, the relationship between supplier 102 and other supplier locations in the same company may be compared to determine relative performance for locations operated or related to the same company.

### Matching

The tier structure of suppliers is able to be used in matching suppliers with customers or jobs based on any number of factors such as supplier factors (e.g., location, quality), job factors (e.g., visibility of the job), customer factors (e.g., very specific requirements set by the customer), end user factors, external factors (e.g., weather) and/or any other factors.

In some embodiments, the customers are tiered as well. For example, customer factors are utilized and analyzed to classify the customers. Furthering the example, job visibility, timeliness requirements, job requirement specificity, typical budget, payment timeliness, contractual obligations, history of litigiousness, history of damaging equipment, customer job type, customer industry, customer credit profile, and other factors are able to be used to analyze and compare the customers with each other and the suppliers.

By rating the suppliers and customers or using tiered suppliers and tiered customers, a matchmaking scheme is able to be implemented to ensure the proper supplier is matched with the appropriate customer so that each party is satisfied. In some embodiments, aspects are provided weights such that some aspects are worth more than others. For example, although a supplier may have a higher price for the rental, because other factors such as timeliness and quality of product are weighted more or outweigh the higher price, that supplier is still selected as supplier for the customer.

In some embodiments, the date of joining the management system managed by the management entity 100 is a factor in determining when a supplier 102 is used. For example, in some embodiments, if a supplier 102 is new, they are given preference to be matched with a customer 104, so that the supplier 102 is able to be evaluated. In some embodiments, new suppliers are placed in a separate tier (e.g., “new suppliers tier”), and customers are matched with suppliers in the “new suppliers tier” before any other tier is analyzed.

In an additional embodiment, the management system actively engages in avoidance or encouragement of concentration of rentals with a supplier 102 (or suppliers related to supplier 102). In this embodiment, the management system weighs factors such as the quantity, frequency, and total revenue of past and current rentals with supplier 102 when matching suppliers with jobs.

In an additional embodiment, a customer's preference of supplier factors into the management entity 100's matching of suppliers with jobs. For example, a customer 104 may prefer to rent from a given supplier 102. Management entity 100 may take this preference into consideration when evaluating suppliers for a job.

### Utilization Opportunities and Load Balancing

The management entity 100 is also able to utilize its knowledge base to determine utilization opportunities and balance loads as the demand and availability for equipment in a particular area changes. In some embodiments, the knowledge base includes work locations, areas in need of equipment, or other similar information. In some embodiments, the additional information is acquired from another source (e.g., an external database or a link to a data source). For example, if a natural disaster occurs in one area, it is likely that the local suppliers will exhaust their inventory, while non-local suppliers may have an opportunity to make money but do not have the capability or desire to explore outside their local area. The management entity 100 is able to locate the non-local suppliers and utilize them for business the non-local supplier would have never realized. Additionally, by supplying equipment from outside the local area, management entity 100 may help discourage or prevent price gouging which could otherwise arise from local equipment scarcity resulting from a natural disaster, terrorist attack, or other event which limits or exhausts the locally available equipment inventory.

Additional information is also able to be factored in when suppliers are providing equipment outside of a local area such as hauling, freight, shipping costs, insurance costs, the necessity of tolls or permits.

In some embodiments, a system utilized by the management entity 100 tracks events such as weather, earthquakes, terrorist attacks, other disasters, sporting events, political events and entertainment events, and the system utilizes information related to the events in conjunction with inventory information, location information and/or any other aspects described herein to locate suppliers for potential customers/jobs. In another embodiment, the management entity 100 observes the depletion of available equipment inventory by checking with the supplier to obtain current equipment inventory status. In this embodiment, inventory checking may be performed by one or more humans or an automated system calling the supplier to make the inquiry. Alternatively, the checking may also be performed by a computer system which has access to the supplier's equipment inventory.

In some embodiments, a system utilized by the management entity 100 utilizes the prediction of events in conjunction with inventory information, location information and/or any other aspects described herein to locate suppliers for potential customers/jobs. For example, a blizzard is predicted to hit only upstate New York but not come close to New Jersey. Using this information, suppliers in New Jersey are able to preemptively send their equipment (e.g., snow plows) to upstate New York for the likely additional work. Specific factors are able to be utilized to ensure predictive work is fruitful. For example, if there is only a 50% chance the blizzard will hit upstate New York, or if there is a chance the blizzard will hit New Jersey as well, then the supplier may not send its equipment. Similarly, to accommodate heavy demand for equipment related to shipping based on the holidays, equipment is able to be pre-positioned.

In another embodiment, rather than moving equipment from outside the local area, the management entity may pre-rent equipment in the local area, in advance of the event which is anticipated to exhaust supply. In this embodiment, the management entity is able to benefit from having equipment available to utilize, and avoids potential hauling fees and liability related to moving equipment.

### Financing/Risk Management

As described herein, the management entity 100 is able to track and determine which equipment is available at suppliers. In addition, the management entity 100 is also able to track what equipment customers are asking for. For example, if the management entity 100 receives 1000 separate requests for a fork lift and is unable to find a local supplier with a fork lift, that information is valuable from a purchasing and financing standpoint. The information is able to be used to enable a supplier to purchase equipment whose likely utilization will be high. Suppliers can also more readily receive a loan from a bank to purchase the fork lift since it is very clear that there is a high demand for the fork lift which means the supplier will likely receive income for renting the fork lift which means the supplier is less likely to default on a loan for the fork lift.

### Equipment Substitution

In some situations, a customer requests a type of equipment with certain minimum characteristics. While a particular piece of equipment may be well suited, a different but similar type of equipment may suffice or even be better. For example, a customer 104 wants to rent a 40 foot scissor lift. The management entity 100 determines that a 50 foot scissor lift is actually available for a cheaper price or from a higher-rated supplier, so the 50 foot scissor lift is recommended or provided. In some embodiments, additional details about the customer and/or work/job are utilized in providing a recommendation. For example, is the job indoor/outdoor or rough terrain, what is the clearance, weight capacity of the flooring or work surface, and other characteristics of the job are able to be utilized to intelligently substitute equipment. In some embodiments, equipment is substituted if the requested equipment is not available, and in some embodiments, equipment is substituted or recommended for substitution even if the requested equipment is available. In some embodiments, the customer is able to select (preemptively) if they are willing to use substituted equipment.

### Rental Inventory Portal

Suppliers are able to use a portal (e.g., web site or application) to provide the management entity 100 pricing and availability for selected inventory. Using the portal, a supplier is able to select equipment for rent through the management entity 100 and set pricing for the selected equipment. The management entity 100 rates and ranks the suppliers as described herein including categorizing the supplier/equipment. Additionally, the suppliers will able to retrieve feedback, reviews regarding performance, and/or other information regarding their rentals. Furthermore, the portal may provide data and analytics to the supplier including and not limited to: details of their historical rental performance, details of rentals which they were offered by the management entity but which they declined to fulfill, details of rentals which were offered to other suppliers by the management entity rather than themselves. The portal may provide guidance regarding increasing or decreasing the supplier's likelihood of selection by the management entity for a particular type of rental equipment (or all rental equipment) by suggesting changes in supplier behavior such as different pricing, better performance in response to issues, having fewer issues overall, and other factors related to the supplier and its operations of its rental business, its interactions with the customer and end-user, and its interactions with the management entity.

In some embodiments, the portal includes a capability to enable bidding between the suppliers. For example, if a customer 104 asks the management entity 100 for 20 scissor lifts, it is unlikely that a single supplier will be able to meet this request, so a bidding system is able to be used for a group of suppliers to separately meet this demand. In some embodiments, the management entity 100 posts a price, and the suppliers are able to then agree or accept that price and specify the number of equipment. In other words, the suppliers are able to pull jobs from a queue of jobs to provide rental equipment.

In a further embodiment, supplier 102 may utilize a computer-based system to manage aspects of their rental equipment inventory. In this embodiment, management entity 100 may integrate with said system. This integration may provide the ability to initiate or conclude rentals, and/or the ability to receive information regarding supplier-owned equipment, equipment availability, pricing, and special pricing.

### Idle Equipment

The management entity 100 is able to track job status and equipment use information. For example, if a job is delayed and is known to be delayed for a set period of time, the equipment will sit idle, or similarly, if a job has been completed early, the equipment is already paid for a set amount of time, but is no longer needed. This idle time is able to be detected by the management entity 100, and the utilization of the equipment is able to be optimized. For example, instead of returning the equipment to the supplier 102, the equipment is able to be moved to the next customer saving on time and other costs.

In a specific example, if the management entity 100 effectively rents equipment for a month (and pays for a month to the supplier) for a customer 104, but the customer 104 only uses the equipment for 2 weeks, then the management entity 100 is able to provide the equipment to another customer for the remaining 2 weeks without having to pay the supplier again, since the management entity 100 paid for a month already.

### Managing the Life Cycle

In a smooth equipment rental, equipment is provided and returned on time without any delays or issues. However, in many instances there are delays or issues, some foreseen and some unforeseen, such as weather delays, equipment failures/issues, customer not being prepared to receive/return the rental equipment, a supplier not being prepared to provide/pick up the rental equipment, the project/job taking longer than expected requiring an extension of the rental, and/or any other delay/problem/issue/situation affecting the rental. The management entity 100 is able to monitor the status of the equipment such as receiving updates, real-time determination of where the equipment is at any given time, who is supposed to have the equipment, and any other information about the equipment. Additionally, the management entity 100 is able to automatically send messages (e.g., voice call, email, SMS messages, Tweets) to entities such as customers or suppliers regarding status updates, so that everyone is updated immediately to limit any confusion. The management entity 100 is able to perform any other management tasks to optimize the rental of the equipment.

### Extension Prediction

In some instances, it is possible for the management entity 100 to predict delays (e.g., due to weather) which will cause extensions for rentals. The management entity 100 is able to factor in items such as job type, equipment type, revenue forecast from extensions, customer's propensity for extensions, and any other inputs. For example, an indoor job not likely be affect much be inclement weather; however, many outdoor jobs will, but further, there are many outdoor jobs that can still be performed in the rain, so the specifics of the job/equipment and other factors are able to perform a better prediction of extensions.

### Hardware

In some embodiments, hardware is installed on/with equipment and/or utilized with the equipment for tracking purposes as well as any other purpose. For example, rental equipment may include GPS technology or other monitoring capabilities so that its current location is able to be determined and tracked, and other information (e.g., engine hours, vital fluid levels) is able to be monitored. The information is able to be used in conjunction with a customer portal (e.g., a web site or app through which a customer is able to view equipment rental information including any monitored information). In an example, a specifically modified piece of equipment is designed to include GPS hardware which enables the management system to track the equipment.

### Advertising

In some embodiments, advertising involves displaying a different phone number, SMS short code, email address, mailing address, or social media identity to contact the management entity 100 to a user based on how the user found the management entity 100. For example, phone number xxx-xxx-xxx1 is displayed to a user if they found the management entity 100 by searching using a particular search engine and search criteria. However, phone number xxx-xxx-xxx2 is displayed to the user if they found the management entity 100 by clicking an advertisement displayed on a particular website. Any number of different phone numbers are able to be utilized. The phone number is displayed when the user visits the management entity's website. The specific phone number is able to be remembered for the user (e.g., through the use of cookies), so that when the user re-visits the management entity's site, the same number is presented. In some embodiments, the first number displayed to the user remains the same regardless of additional clicks. In some embodiments, if the user visits the management entity's site through a different advertisement, then the phone number displayed changes. For example, if the user clicks a search engine result link for the management entity's website, a first phone number is displayed, but then a week later, the user clicks an advertisement displayed while the user is viewing his email, a second phone number is displayed on the website. By utilizing different means of contact (such as phone numbers), the management entity is able to monitor the effectiveness of the advertising campaigns. Additionally, other information is able to be modified based on how the user enters/finds/contacts the management entity. For example, different email addresses are utilized.

In some embodiments, rental dollars, satisfaction, equipment types, customer characterization and well as other information are able to be linked with the particular advertising channels. For example, customers utilize the service after finding the management company based on Advertising X are 95% satisfied, which encourages the management company to continue utilizing Advertising X or invest more into Advertising X. In another example, when a “boom lift” keyword search is performed using a search engine, that drives a particular profile customer that has a certain economic outcome, and these customers when they are located in the Southeast typically rent a certain type of equipment at a certain time of year, and all of this information is able to be used/incorporated with prediction and other analytics and optimization.

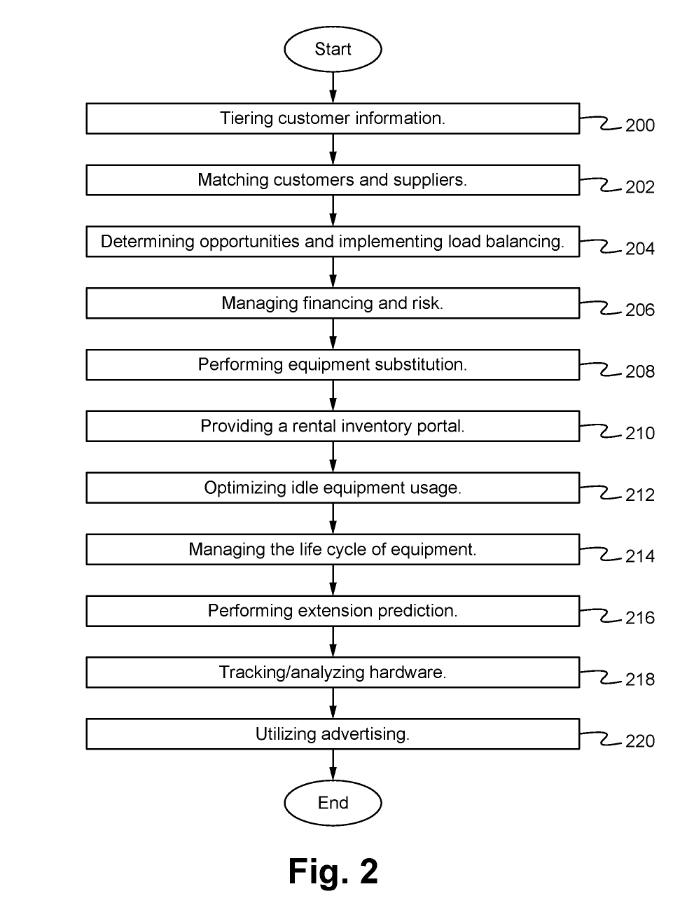

FIG. 2 illustrates a flowchart of a method of implementing a management system according to some embodiments. In the step 200, customer information is tiered. In the step 202, suppliers and customers are matched. In the step 204, opportunities are determined and load balancing is implemented. In the step 206, financing and risk is managed. In the step 208, equipment substitution is performed. In the step 210, a rental inventory portal is provided. In the step 212, idle equipment is optimized. In the step 214, the life cycle of equipment is managed. In the step 216, extension prediction is performed. In the step 218, hardware is tracked/analyzed. In the step 220, advertising is utilized. In some embodiments, fewer or additional steps are implemented. For example, in some embodiments, the steps of acquiring customer and supplier information are included. In another example, the steps of receiving a rental request as well as a completion of a request (e.g., after a customer returns the equipment, the appropriate parties are paid) are included. In some embodiments, the order of the steps is modified. In some embodiments, any of the steps are implemented separately or independently. In some embodiments, any of the steps include one or more sub-steps.

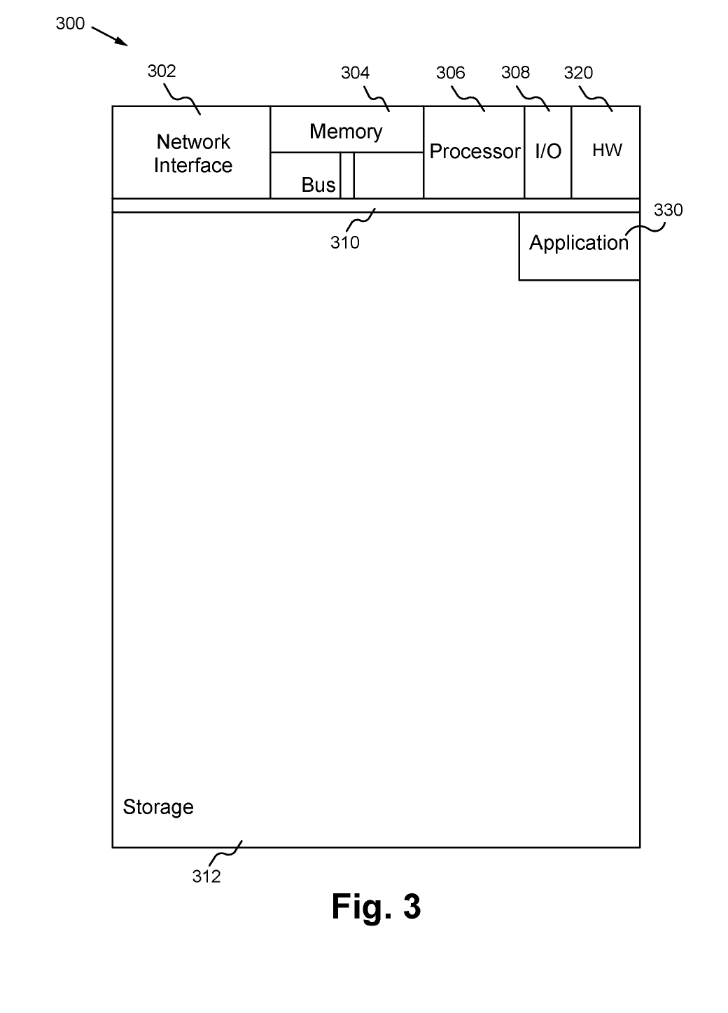

FIG. 3 illustrates a block diagram of an exemplary computing device configured to implement the management system according to some embodiments. The computing device 300 is able to be used to acquire, store, compute, process, communicate and/or display information. The computing device 300 is able to implement any of the steps, methods or functions described herein automatically, without user input, or with user input. In general, a hardware structure suitable for implementing the computing device 300 includes a network interface 302, a memory 304, a processor 306, I/O device(s) 308, a bus 310 and a storage device 312. The choice of processor is not critical as long as a suitable processor with sufficient speed is chosen. The memory 304 is able to be any conventional computer memory known in the art. The storage device 312 is able to include a hard drive, CDROM, CDRW, DVD, DVDRW, Blu-Ray®, flash memory card or any other storage device. The computing device 300 is able to include one or more network interfaces 302. An example of a network interface includes a network card connected to an Ethernet or other type of LAN. The I/O device(s) 308 are able to include one or more of the following: keyboard, mouse, monitor, display, printer, modem, touchscreen, button interface and other devices. In some embodiments, the hardware structure includes multiple processors and other hardware to perform parallel processing. Management system application(s) 330 used to perform the management method are likely to be stored in the storage device 312 and memory 304 and processed as applications are typically processed. More or fewer components shown in FIG. 3 are able to be included in the computing device 300. In some embodiments, management hardware 320 is included. Although the computing device 300 in FIG. 3 includes applications 330 and hardware 320 for implementing the management method, the management method is able to be implemented on a computing device in hardware, firmware, software or any combination thereof. For example, in some embodiments, the management applications 330 are programmed in a memory and executed using a processor. In another example, in some embodiments, the management hardware 320 is programmed hardware logic including gates specifically designed to implement the method.

In some embodiments, the management application(s) 330 include several applications and/or modules. In some embodiments, modules include one or more sub-modules as well.

Examples of suitable computing devices include a personal computer, a laptop computer, a computer workstation, a server, a mainframe computer, a handheld computer, a personal digital assistant, a cellular/mobile/smart telephone (e.g. an iPhone®), a smart appliance, a tablet computer (e.g. an iPad®), a smart watch, or any other suitable computing device.

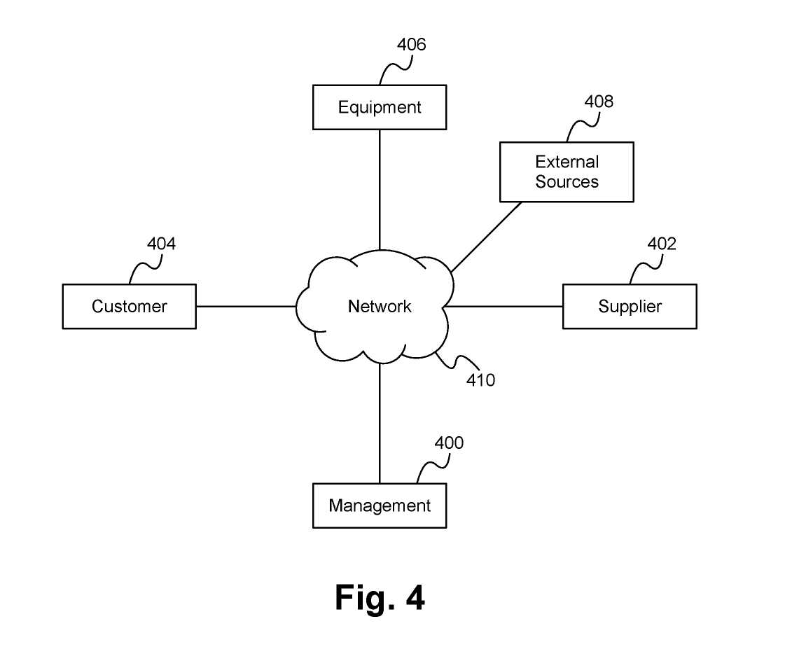

FIG. 4 illustrates a network of devices configured to implement the management system according to some embodiments. The network of devices is able to include any number of devices and any various devices including, but not limited to, a management device 400, a supplier device 402, a customer device 404, equipment 406 and external sources 408 coupled through a network 410 (e.g., the Internet). The network 410 is able to be any network or networks including, but not limited to, the Internet, an intranet, a LAN/WAN/MAN, wireless, wired, cellular, Ethernet, satellite, a combination of networks, or any other implementation of communicating. The devices are able to communicate with each other through the network 410 or directly to each other.

For example, the management device 400 receives a rental request from a customer device 404, and based on the rental request sends a rental request to a selected supplier device 402 based on knowledge/data accessible by the management device 400 (e.g., tiered supplier information and other matchmaking information). The supplier device 402 responds with a rental acknowledgment. The management device 400 is able to track the location of the equipment 406 using GPS embedded in/connected to the equipment or another tracking technology. The management device 400 is also able to automatically perform any of the management tasks described herein utilizing internal sources (e.g., databases) or the external sources 408 (e.g., external databases, web page information). For example, the management device 400 is able to be coupled to a weather database and perform analytics of the weather information to predict extensions. Although only a limited number of devices are shown in FIG. 4, any number of devices are able to be implemented. For example, there are able to be multiples of each of the management devices, supplier devices, customer devices, equipment and/or external sources.

In some instances, a customer asks a supplier for rental equipment, and the supplier only has some of the equipment, so the supplier has three options: decline to help the customer, offer only the specific equipment that the supplier has which leaves the customer needing to rent the remaining equipment from another supplier, or the supplier informs the customer that the supplier has all of the rental equipment, but actually rents some of the equipment from another supplier to supplement the equipment the supplier has, thus fulfilling the entire request. Each option has challenges and downsides. In the first case, the supplier would lose the rental revenue and disappoint the customer. In the second case, the supplier would be encouraging the customer to establish a relationship with a competitor and thus risks the competitor (who may have all the equipment the customer needs) taking the entire order. In the third case, the supplier fulfills the customer's needs however the process of a supplier renting equipment from another supplier is typically not smooth since it involves researching and locating the appropriate supplier with the correct equipment, tracking the rented equipment as well as other billing, accounting, and managerial tasks that the supplier may not be comfortable with or effective at.

In some embodiments, the management entity implements a supplier extended inventory system. By utilizing the management entity, when a customer asks a supplier for rental equipment not currently in the supplier's available inventory, the supplier is able to answer, “yes” that they are able to fulfill the customer's entire request, and the management entity helps the supplier do so, transparently to the customer. The management entity utilizing the systems and methods described herein is able to locate and communicate with additional suppliers to provide the equipment to the customer and monitor the supplier's fleet availability, as well as other services. For example, if a customer asks to rent a boom lift from the supplier, but the supplier has recently rented out his last boom lift or does not carry boom lifts with the required attributes, the supplier is still able to affirmatively answer “yes” to the customer's request, and the management entity locates an additional supplier with a boom lift, and that boom lift is rented from the supplier by the management entity and supplied to the customer. Further, over the course of time, the management entity tracks the renting supplier's boom lift fleet availability and may determine that one is presently available. The management entity may coordinate to swap out the supplier's boom lift once it is available. In another embodiment, the management entity may analyze historical availability trends and supplier-provided availability projections to prospectively identify likely instances where a boom lift rented from another supplier may become available in the supplier's fleet. The management entity may communicate this fact with the supplier to cause the supplier to hold that equipment and not rent it out, with the intention of swapping the soon-to-be-available equipment for the equipment being rented from the competing supplier. This communication may be manual or automated, and could include a computer system integration which automatically causes the equipment to be held in anticipation of a swap. By utilizing the management entity, the supplier gains the benefit of being able to say “yes” to any or most requests, as well as minimize the amount of cost and logistical challenges which arise for renting from other suppliers. Furthering the example, if the supplier in the previous example did not carefully track its rentals, it may have rented the boom lift from a competitor to the customer for several weeks while one of its own boom lifts is sitting in its lot being unused, meaning the supplier has an additional cost and lost income on its own equipment. The management entity is also able to price compare and perform other analysis described herein (e.g., inventory analysis and management of equipment of suppliers in a specified area, job status tracking to predict when equipment may be available, similar equipment replacement analysis to rent similar equipment at a cheaper price) which benefit the supplier and supplier's customers. In a similar example, the management entity monitors equipment rented for a supplier, and when equipment is indicated as returned, the management entity automatically arranges to swap out the equipment provided by an additional supplier, and the additional supplier's equipment is returned to them. The management entity also manages the logistics of the swap as well to ensure all parties are satisfied with the swap. For example, the management entity contacts the customer to confirm a satisfactory swap time to prevent any disruptions of activities the customer is undertaking.

In some embodiments, a supplier is given priority or preferential treatment with the management entity, if the supplier rents equipment using the management entity. By being able to rent additional equipment from other suppliers, a supplier is able to bid on jobs outside their typical class. For example, if a supplier only has lifting equipment (e.g., scissor lifts and boom lifts) but does not have earth moving equipment (e.g., excavators, bulldozers), then the supplier would typically be excluded from consideration for a job that requires both types of equipment. However, by utilizing the management entity and the implementation of efficiently re-renting equipment from other suppliers, the supplier is able to confidently bid on those types of jobs since they will have or have access to the desired equipment. In addition to satisfying the customer and retaining the rental revenue, this capability allows the supplier to avoid utilizing its capital for rental equipment purchase: in effect, the management entity provides a capital expenditure replacement capability for the supplier.

In some embodiments, suppliers will have access to the supplier extended inventory implementation through a supplier portal made available by the management entity. In some embodiments, this portal and/or the underlying systems and methods under control of the management entity may be programmatically integrated with the supplier's own systems and methods to enhance the effectiveness of the relationship between the management entity and the supplier.

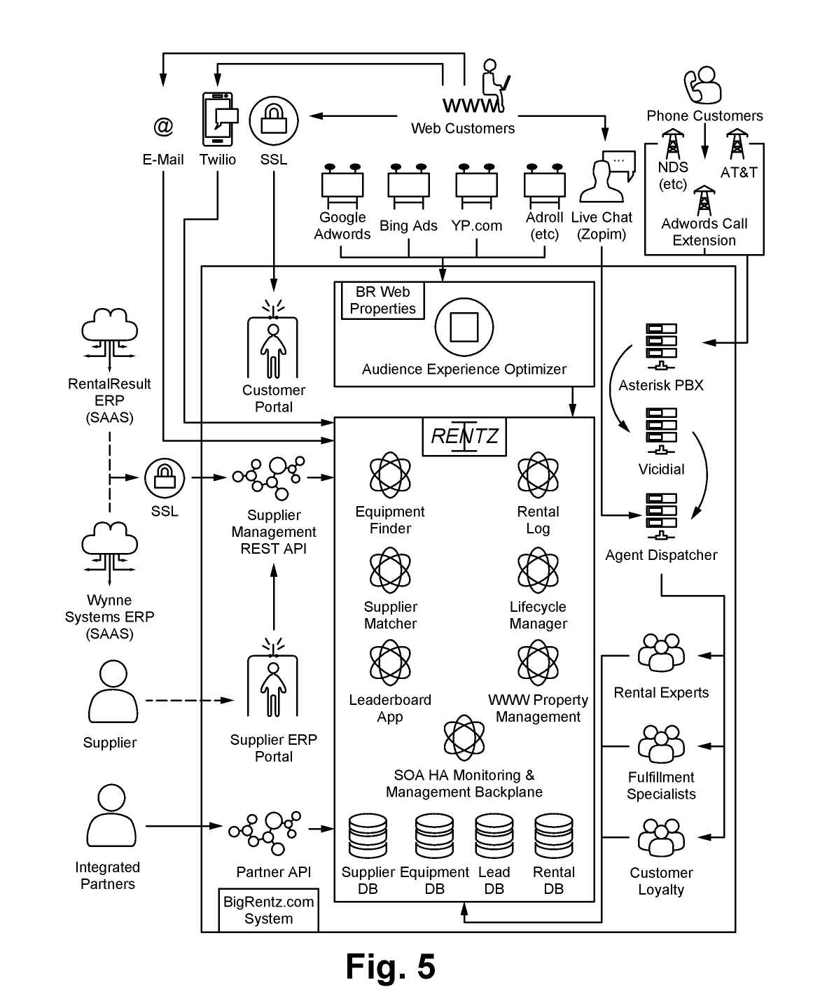

FIG. 5 illustrates a diagram of the management system according to some embodiments. The management system accesses one or more databases such as a supplier database, equipment database, lead database, and rental database. These databases are able to be used to perform the management analysis as described herein such as generating tier structures. The management system also implements one or more applications/systems such as an equipment finder, a rental log, a supplier matcher, a lifecycle manager, a leaderboard application, a world wide web property manager, and a monitoring and management backplane (e.g., an Oracle SOA high availability monitoring and management backplane).

The management system includes a partner Application Programming Interface (API) to enable integrated partners to interface with the management system. The management system also includes a supplier ERP portal as described herein. A supplier management REpresentational State Transfer (REST) API enables communication between the management system and external (rental) systems such as Wynne Systems Equipment Rental Companies (ERP) and RentalResult ERP. In some implementations, the communications utilize Secure Socket Layers (SSL) for security. As described herein, the management system also includes a customer portal, which is also able to implement SSL for secure communications. Customers are able to communicate with the management system via email, Twilio (e.g., text and other messages), and any other communication (e.g., live chat, phone call). Advertisers are able to interface with the management system, and an audience experience optimizer is utilized to improve the experience from both the advertiser and the customer/supplier perspective as well as the management system perspective. Phone customers are able to contact the management system, and using a variety of phone and computing technologies (e.g., Asterisk PBX, Vicidial, Agent dispatcher), the calls are routed to the appropriate personnel (e.g., rental experts, fulfillment specialists, customer loyalty handlers) who have access to the management system. The management system described in reference to FIG. 5 is not meant to be limiting in any manner. The management system is able to include fewer or additional elements/aspects, and although specific features have been used as examples, any generic or comparable technology is able to be used instead of or in addition to the specific examples.

To utilize the management system, a management entity acquires supplier data, customer data and additional data. The management system automatically processes the data, which the management entity is able to utilize to efficiently manage equipment rentals. In some embodiments, data is manually provided, automatically provided or a combination of both to the management system.

In operation, the management system receives/analyzes supplier data, customer data, external data and any other data to efficiently manage equipment rentals and provide additional services. Any of the management steps are able to be performed automatically to ensure that an optimized management scheme is implemented.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A system comprising:
a. equipment configured with GPS-enabled hardware; and
b. a device configured for:
i. receiving a rental request by a customer at a management entity;
ii. renting the equipment from a supplier by the management entity without physically acquiring the equipment;
iii. providing the customer the ability to temporarily acquire the equipment based on the management entity rental; and
iv. tracking the equipment via GPS, wherein the tracking improves management of the equipment.

2. The system of claim 1 wherein the device is further configured for:
analyzing customer information to generate a customer tier structure of customers;
analyzing supplier information to generate a supplier tier structure of suppliers; and
matching the supplier and the customer based on the customer tier structure and the supplier tier structure.

3. The system of claim 2 wherein the device is further configured for:
generating a knowledge base using the customer information and the supplier information; and
utilizing the knowledge base and tracked, predictive external information to match a non-local customer with the supplier by performing load balancing.

4. The system of claim 1 wherein the device is further configured for:
analyzing equipment inventory to generate inventory analysis;
analyzing equipment demand to generate demand analysis; and
providing the inventory analysis and the demand analysis to facilitate a loan transaction.

5. The system of claim 1 wherein the device is further configured for:
analyzing equipment inventory; and
intelligently recommending an equipment substitution based on job information, customer information, supplier information and the analyzed equipment inventory.

6. The system of claim 1 wherein the device is further configured for:
displaying a supplier user interface enabling one or more suppliers to perform at least one task selected from the group consisting of: offer rental equipment, place bids on offered jobs, set pricing for the rental equipment, retrieve feedback and reviews regarding performance, access analytics of rentals, and manage the rental equipment; and
displaying a customer user interface enabling one or more customers to view managed equipment information.

7. The system of claim 1 wherein the device is further configured for:
tracking a status of a job for the customer including the equipment;
determining when the job is finished to generate a finished date;
comparing the finished date with a rental return date;
analyzing current equipment rental requests for a second customer and corresponding time frames;
comparing the difference between the finished date and the rental return date and the corresponding time frames;
comparing the current equipment rental requests and the equipment from the finished job; and
if there is a time frame match and an equipment match, then providing the same equipment to the second customer.

8. The system of claim 1 wherein the device is further configured for:
providing a management implementation of equipment to enable the supplier to supply to the customer the equipment the supplier has and the equipment the supplier does not have by renting the equipment the supplier does not have available from an additional supplier; and
managing a swap of the equipment rented from the additional supplier after determining the supplier has the equipment available.

9. A method programmed in a non-transitory memory of a device comprising:
a. receiving a rental request by a customer at a management entity;
b. renting equipment from a supplier by the management entity without physically acquiring the equipment; and
c. providing the customer the ability to temporarily acquire the equipment based on the management entity rental.

10. The method of claim 9 further comprising:
analyzing customer information to generate a customer tier structure of customers;
analyzing supplier information to generate a supplier tier structure of suppliers; and
matching the supplier and the customer based on the customer tier structure and the supplier tier structure.

11. The method of claim 10 wherein the supplier information comprises at least one of: location, rental price, credit terms, prior behavior in cases of dispute, equipment/inventory, quality and characteristics of the equipment, quality of service, quality of the mechanic for the equipment, jobs/rentals performed/completed, commentary/reviews of customers/end users, commentary/reviews of the management entity, number of times a rental was proposed by the management entity and number of times a rental was successfully concluded by the management entity with said supplier; and the customer information comprises at least one of: predicted customer satisfaction, customer history, job visibility, timeliness requirements, job requirement specificity, typical budget, payment timeliness, contractual obligations, history of litigiousness, history of damaging equipment, customer job type, customer industry and customer credit profile.

12. The method of claim 11 wherein elements of the supplier information and the customer information are weighted differently to generate the supplier tier structure.

13. The method of claim 10 further comprising:
generating a knowledge base using the customer information and the supplier information; and
utilizing the knowledge base and tracked, predictive external information to match a non-local customer with the supplier by performing load balancing.

14. The method of claim 9 further comprising:
analyzing equipment inventory to generate inventory analysis;
analyzing equipment demand to generate demand analysis; and
providing the inventory analysis and the demand analysis to facilitate a loan transaction.

15. The method of claim 9 further comprising:
analyzing equipment inventory; and
intelligently recommending an equipment substitution based on job information, customer information, supplier information and the analyzed equipment inventory.

16. The method of claim 9 further comprising performing at least one task selected from the group consisting of: displaying a user interface enabling one or more suppliers to offer rental equipment, place bids on offered jobs, set pricing for the rental equipment, retrieve feedback and reviews regarding performance, access analytics of rentals, and manage the rental equipment.

17. The method of claim 9 further comprising:
tracking a status of a job for the customer including equipment;
determining when the job is finished to generate a finished date;
comparing the finished date with a rental return date;
analyzing current equipment rental requests for a second customer and corresponding time frames;
comparing the difference between the finished date and the rental return date and the corresponding time frames;
comparing the current equipment rental requests and the equipment from the finished job; and
if there is a time frame match and an equipment match, then providing the same equipment to the second customer.

18. The method of claim 9 further comprising:
analyzing factors related to currently rented out equipment; and
predicting extensions of the rented out equipment based on the factors.

19. The method of claim 9 further comprising:
tracking equipment of the supplier configured with GPS-enabled hardware; and
utilizing the tracking to improve management of the equipment.

20. The method of claim 9 further comprising: displaying a customer user interface enabling customers to view managed equipment information.

21. The method of claim 9 further comprising:
providing a plurality of different phone numbers based on an access point; and
modifying advertising based on analysis of the plurality of different phone numbers.

22. The method of claim 9 further comprising:
providing a management implementation of equipment to enable the supplier to supply to the customer the equipment the supplier has and the equipment the supplier does not have by renting the equipment the supplier does not have available from an additional supplier; and
managing a swap of the equipment rented from the additional supplier after determining the supplier has the equipment available.

23. The method of claim 9 further comprising:
utilizing the management entity, by the supplier, to rent equipment to the customer; and
enabling the supplier to fulfill jobs that require equipment from a first set of equipment and a second set of equipment, wherein the first set of equipment is the equipment the supplier has and the second set of equipment is the equipment the supplier does not have available.

24. A device comprising:
a. a memory configured for storing an application, the application configured for:
i. receiving a rental request by a customer at a management entity;
ii. renting equipment from a supplier by the management entity without physically acquiring the equipment; and
iii. providing the customer the ability to temporarily acquire the equipment based on the management entity rental; and
b. a processor configured for processing the application.

25. The device of claim 24 wherein the application is further configured for:
analyzing customer information to generate a customer tier structure of customers;
analyzing supplier information to generate a supplier tier structure of suppliers; and
matching the supplier and the customer based on the customer tier structure and the supplier tier structure.

26. The device of claim 25 wherein the application is further configured for:
generating a knowledge base using the customer information and the supplier information; and
utilizing the knowledge base and tracked, predictive external information to match a non-local customer with the supplier by performing load balancing.

27. The device of claim 24 wherein the application is further configured for:
analyzing equipment inventory to generate inventory analysis;
analyzing equipment demand to generate demand analysis; and
providing the inventory analysis and the demand analysis to facilitate a loan transaction.

28. The device of claim 24 wherein the application is further configured for:
analyzing equipment inventory; and
intelligently recommending an equipment substitution based on job information, customer information, supplier information and the analyzed equipment inventory.

29. The device of claim 24 wherein the application is further configured for:
displaying a supplier user interface enabling one or more suppliers to perform at least one task selected from the group consisting of: offer rental equipment, place bids on offered jobs, set pricing for the rental equipment, retrieve feedback and reviews regarding performance, access analytics of rentals, and manage the rental equipment; and
displaying a customer user interface enabling one or more customers to view managed equipment information.

30. The device of claim 24 wherein the application is further configured for:
tracking a status of a job for the customer including equipment;
determining when the job is finished to generate a finished date;
comparing the finished date with a rental return date;
analyzing current equipment rental requests for a second customer and corresponding time frames;
comparing the difference between the finished date and the rental return date and the corresponding time frames;
comparing the current equipment rental requests and the equipment from the finished job; and
if there is a time frame match and an equipment match, then providing the same equipment to the second customer.

31. The device of claim 24 wherein the application is further configured for:
tracking equipment of the supplier configured with GPS-enabled hardware; and
utilizing the tracking to improve management of the equipment.

32. The device of claim 24 wherein the application is further configured for:
providing a plurality of different phone numbers based on an access point; and
modifying advertising based on analysis of the plurality of different phone numbers.

33. The device of claim 24 wherein the application is further configured for:
providing a management implementation of equipment to enable the supplier to supply to the customer the equipment the supplier has and the equipment the supplier does not have by renting the equipment the supplier does not have available from an additional supplier; and
managing a swap of the equipment rented from the additional supplier after determining the supplier has the equipment available.
